(19) United States
(12) Patent Application Publication
(10) Pub. No.: US 2007/0297851 A1
(43) Pub. Date: Dec. 27, 2007

(54) Connector of cross struts

(76) Inventor: Hui Chen, Xiamen (CN)

Correspondence Address: CHARLES E. BAXLEY, ESQ., 90 JOHN STREET, THIRD FLOOR, NEW YORK, NY, 10038, US

(21) Appl. No.: 11/657,838

(22) Filed: Jan. 24, 2007

(30) Foreign Application Priority Data
May 19, 2006 (CN) CN 200620059299.9

(51) Int. Cl. F16D 1/12

(52) U.S. Cl. 403/161

(57) ABSTRACT

The present invention provides a cross-strut connector built on a molded base block with two paralleled through-holes, wherein one through-hole is opened tow U-shaped grooves separately on opposite sides and opposite ends crossly; two cross struts are fit into the two through-holes respectively, and pivoted on the base block in place by a pivot piece. Because the both cross struts can be set on the parallel through-holes, and one is always fit into one through-hole working as a sleeve, another can be rotated in another through-hole opened with two opposite U-shaped grooves to carry out opening and closing the two cross struts functions, because the cross strut is purported by the two bottom sides of the U-shaped grooves as the folding chair is opened fully, the two beveled surfaces of the bottom sides of the two U-shaped grooves increase the contact area with the strut so as to strengthen the standing strength of the connector, the clincher crossing the whole base block passing through the both through-holes is reinforced so as to avoid efficiently distortion and break-off happening, further to delaying the service life of the chair, meanwhile the volume of the connector is smaller with good external look.

### BACKGROUND OF THE INVENTION

1. Field of the Invention

The present invention relates to a folding camp chair, and more particularly to a connector of cross struts in said folding camp chair.

2. Description of Prior Art

In accordance with the conventional folding camp chairs in the market so far, the most of struts are crossly connected in pivoting connection for unfolding or gathering up. In the structure of them, as shown in FIG. 1, the two cross struts are usually connected crossly via a clincher for bearing the extra force on the connecting spot, but during a long time using, said clincher is easy to be distorted, even to be broken off directly to affect the service life and safety of use.

For solving the problems above-mentioned, an invention patent number being 00255139 declared <a cross-struts connector for folding camp chair> is a cylinder, as shown in FIG. 2 and FIG. 3, diametrally drilled two 8-shaped through-holes separately in interlacing arrangement; said two cross struts are fit into the two 8-shaped through-holes separately, and riveted on the cylinder; said two 8-shaped through-holes are arranged in a separation angle between them so that said two cross struts can rotate an angle separately in each 8-shaped through-hole to carry out crisscrossing or closing up, so the contacting area of the connection of the two cross struts is increased for avoiding the clincher distorting or breading off after long time use, further to delaying the service life of the chair.

But in the structure of said connector, two interlaced 8-shaped through-holes offering the rotation moving spaces to the cross struts simultaneously make the whole body of the connector so big that the material is wasted and the external look is affected; on the other hand, often moving in the through-holes, said cross struts are apt to friction against the inside walls of the through-holes, so that the struts are split paint or chipped the wall thinness, further to distort the stem, and affect the service life.

Referring to FIG. 4 and FIG. 5, a patent number is 03216172 declared <a connection mechanism of cross-strut rest>, in which the base body is a sleeve, and extends a corner bracket from the outside wall of the sleeve base body with a separation angle, and the top ends of said corner bracket have an outward ace groove on each, one of the two cross struts is fit into said sleeve, another is hung on said corner bracket.

Although said structure has overcame the shortcomings of big volume of the connector, and easily wear-out, but all the extra force accepted by the opened connector concentrates on the corner bracket so that the connection area between the bracket and the sleeve is easy to be broken off as a heavy person sets on the chair, so the structure of the connector is not get to desired strong enough, and the service life is limited.

### OBJECTS AND SUMMARY OF THE INVENTION

It is therefore a main object of the present invention to provide a cross-strut connector with simplified structure, small volume, high strength features.

For achieving the above-mentioned object, the present invention provides a cross-strut connector being a molded base block with two paralleled through-holes, wherein one through-hole is opened tow U-shaped grooves separately on opposite sides and opposite ends crossly; two cross struts are fit into the two through-holes respectively, and pivoted on the base block in place by a pivot piece.

Said pivot hole passes through the central position of said two through-holes crossly.

Said U-shaped groove should exceed the pivot point.

The bottom side of said U-shaped groove is formed with a beveled surface from the inner to the outer.

As utilizing above-mentioned project, due to the both through-holes forming on one base block, the two cross struts connection can be carried out, and two opposite U-shaped grooves formed on one through-hole, the two cross struts can be opened and closed around the pivot point. There are several advantages of the present invention as follows:
1. simplified structure and small volume, because the both cross struts can be set on the parallel through-holes, and one is always fit into one through-hole working as a sleeve, another can be rotated in another through-hole opened with two opposite U-shaped grooves, so the volume of the base block can be manufactured in smaller with the simplified structure; on the other hand, the pivoting motion of the strut in the U-shaped grooves will not generate friction.
2. high strength, because the cross strut is purported by the two bottom sides of the U-shaped grooves as the folding chair is opened fully, the two beveled surfaces of the bottom sides of the two U-shaped grooves increase the contact area with the strut so as to strengthen the standing strength of the connector, the clincher crossing the whole base block passing through the both through-holes is reinforced so as to avoid efficiently distortion and break-off happening, further to delaying the service life of the chair.

### BRIEF DESCRIPTION OF THE DRAWINGS

FIG. 1 is a perspective view of the prior art.

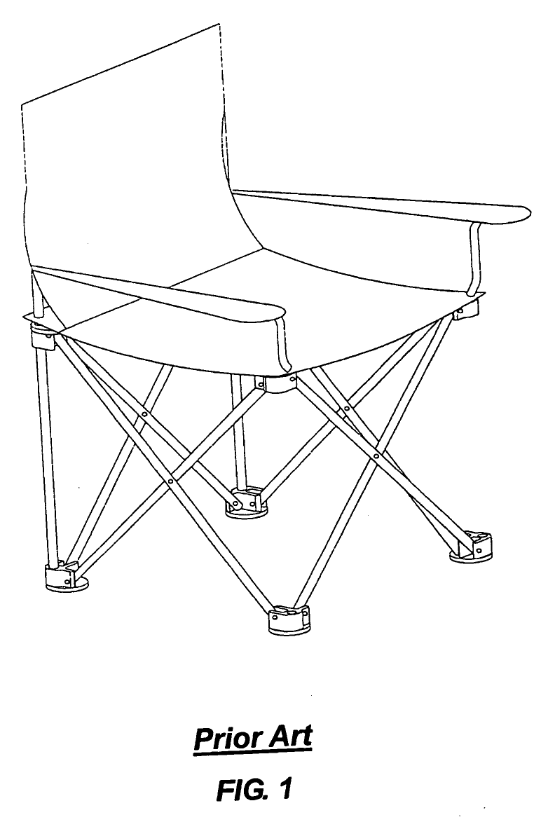

FIG. 2 is an exploded view of the first prior art.

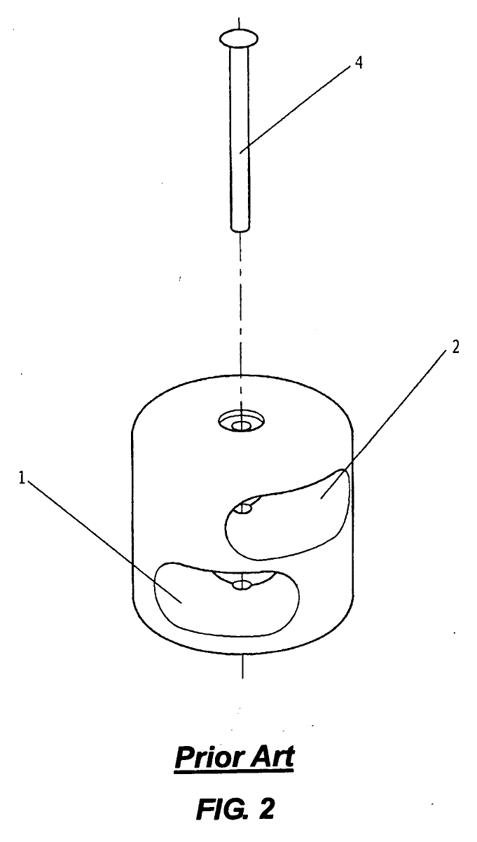

FIG. 3 is a perspective view of the first prior art.

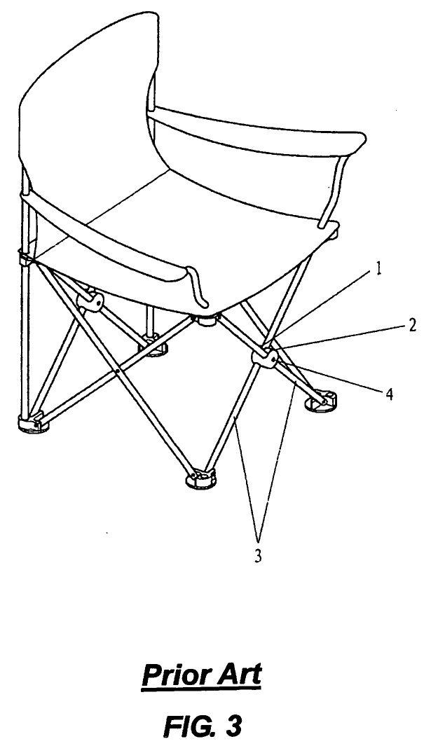

FIG. 4 is an exploded view of the second prior art.

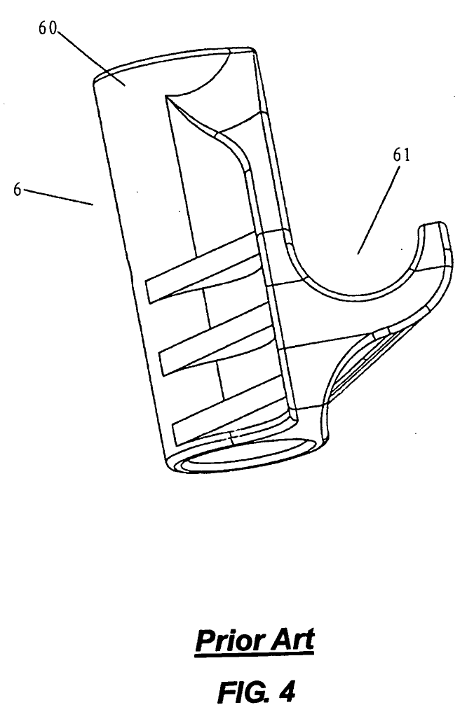

FIG. 5 is a perspective view of the second prior art.

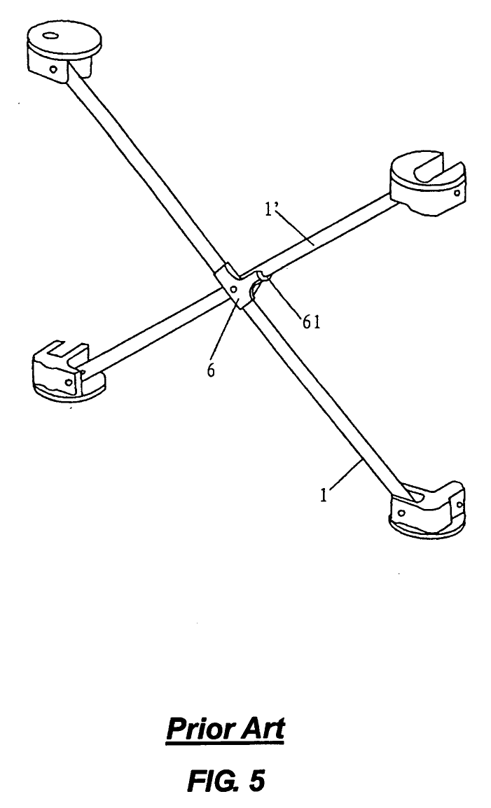

FIG. 6 is a perspective view of the present invention.

FIG. 7 is an exploded view showing the first step in combination of the present invention.

FIG. 8 is an exploded view showing the second step in combination of the present invention.

FIG. 9 is a perspective view showing the use state of the present invention.

FIG. 10 is a perspective view showing the folding state of the present invention.

### DETAILED DESCRIPTION OF PREFERRED EMBODIMENTS

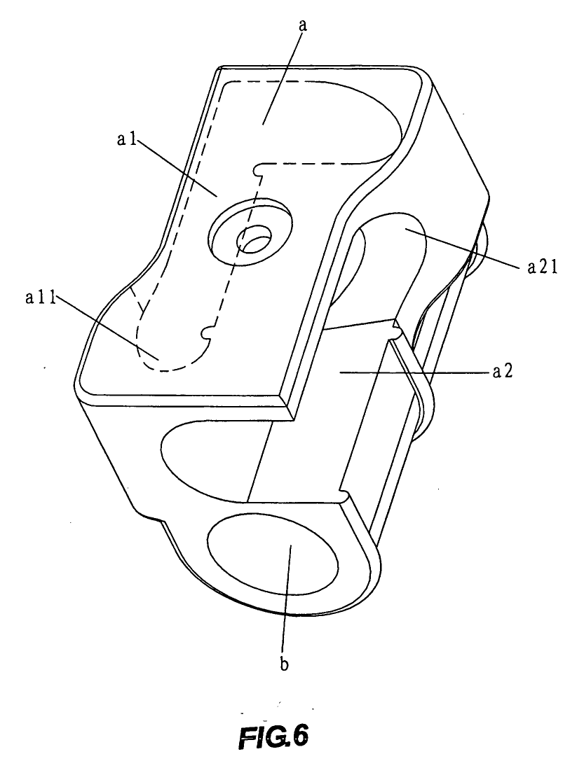

A cross-strut connector provided by the present invention, as shown in FIG. 6, is based on a base block having two parallel through-hole 1 2 for holding two cross struts 31 32 in, and a pivot hole passes through the central position of said two through-holes 1 2 crossly.

Wherein, one of through-hole 1 is opened tow U-shaped grooves 11 12 separately at opposite sides and opposite ends crossly on said base block; said U-shaped grooves 11 12 should exceed the pivot point in the depth individually depending on the open angle of the cross struts 31 32, the deeper the U-shaped grooves 11 12 are, the wider the open angle is; the bottom sides of said U-shaped grooves 11 12 are formed with a beveled surface 111 or 112 from the inner to the outer for nestling up against the strut 32 so as to increase the contacting area.

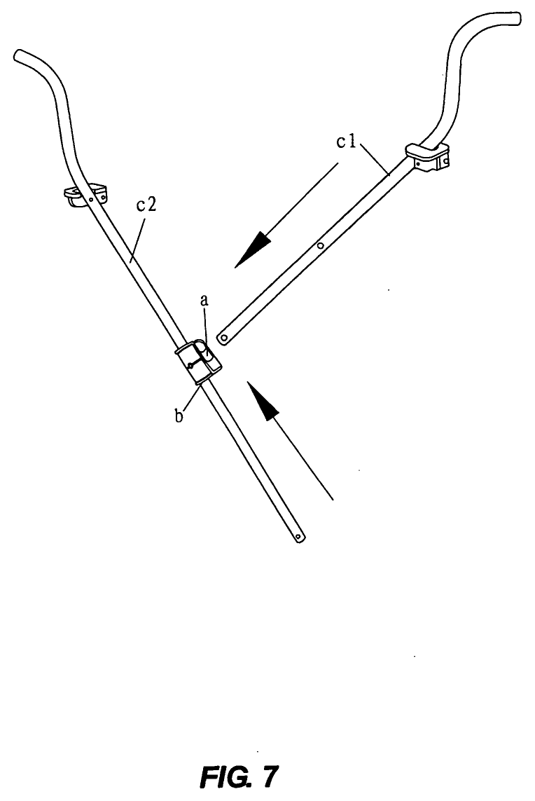

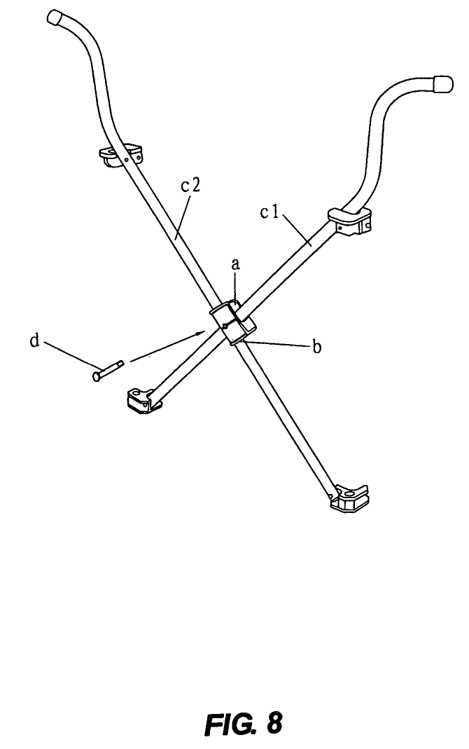

Cooperating to FIG. 7 and FIG. 8, in combination, fit said cross struts 31 32 into the two through-holes 1 2 respectively, and pivot the both struts 31 32 on the base block with the pivot piece 4.

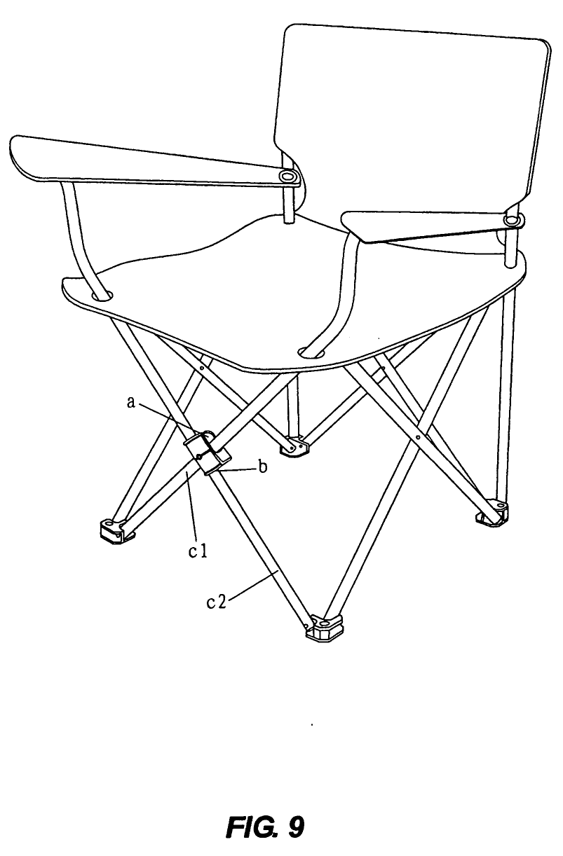

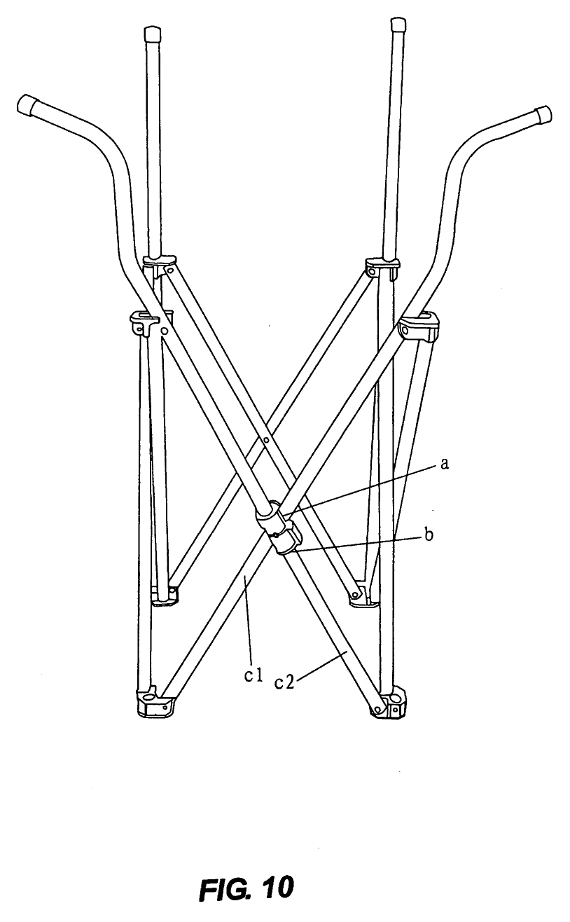

Referring to FIG. 9 and FIG. 10, in practicing, when the folding chair is in idle time, said two cross struts 31 32 are held in the through-holes 1 2 parallelly so as to close up, as shown in FIG. 9; as tending to open the chair fully for use, one strut 32 of the two cross struts 31 32 is held in the through-hole 2, another is rotated over the U-shaped grooves 11 12 around on the pivot point until touching against the bottom sides 111 121 of the U-shaped grooves 11 12. So the depth of the grooves decide the open angle of the cross struts 31 32, further to deciding the height of the chair. Due to the beveled surfaces of the bottom sided 111 121 of the U-shaped grooves 11 12, the contacting areas with the cross struts 31 32 are increased, so the standing strength of the connection portion is increased too without distorting and breaking off happened even if during long time in use, further to delaying the service life of the folding chair; because the two cross struts 31 32 are held in the base block, one is always in the through-hole 2 working as a sleeve, another is in a through-hole 1 opened with two opposite U-shaped grooves 11 12 for pivoting motion, therefore, the structure of the present invention is simple and the volume is relative smaller; on the other hand, said strut 31 moves in said U-shaped grooves 11 12 in pivot rotation without wearing out.

I claim:

1. A cross-strut connector built on a molded base block with two paralleled through-holes, wherein one through-hole is opened tow U-shaped grooves separately on opposite sides and opposite ends crossly; two cross struts are fit into the two through-holes respectively, and pivoted on the base block in place by a pivot piece.

2. A cross-strut connector as claimed in claim 1, wherein said pivot hole passes through the central position of said two through-holes crossly.

3. A cross-strut connector as claimed in claim 1, wherein said U-shaped groove should exceed the pivot point.

4. A cross-strut connector as claimed in claim I or claim 3, wherein the bottom side of said U-shaped groove is formed with a beveled surface from the inner to the outer.
